(19) United States
(12) Patent Application Publication
(10) Pub. No.: US 2024/0205108 A1
(43) Pub. Date: Jun. 20, 2024

(54) NETWORK MONITORING SYSTEM, METHOD, DEVICE, AND PROGRAM

(71) Applicant: RAKUTEN MOBILE, INC., Tokyo (JP)

(72) Inventors: Kishor MUKATI, Indore (IN); Gourav DESHLEHRA, Indore (IN); pankaj PATIL, Indore (IN); Pranay CHAMBHARE, Indore (IN)

(73) Assignee: RAKUTEN MOBILE, INC., Tokyo (JP)

(21) Appl. No.: 17/791,454

(22) PCT Filed: Feb. 28, 2022
(86) PCT No.: PCT/US2022/018109

§ 371 Date: Aug. 31, 2023

(51) Int. Cl. H04L 41/5025; H04L 41/22; H04L 41/5009

(52) U.S. Cl. CPC H04L 41/5025; H04L 41/22; H04L 41/5009

(57) ABSTRACT

A method of network monitoring in a distributed computing environment, the method being performed by at least one processor. The method includes: determining that a network monitoring request was triggered; receiving one or more parameters associated with the network monitoring request; determining computing resources available in a cluster; allocating dedicated computing resources in the cluster based on the computing resources available being insufficient; executing the network monitoring request; and displaying a result of the executed network monitoring request.

### BACKGROUND

Monitoring of network elements in a telecommunication network is vital to ensure efficient functionality of the network infrastructure and optimal use of network resources. For example, real-time time sensitive reports often need to be generated to identify equipment failures in the network infrastructure. However, generating network monitoring reports, depending on the scope of the reports, may require computing resources unavailable at the time or may consume too much time. Therefore, there is a need for resource conscious monitoring of network elements in a telecommunication network.

### SUMMARY

According to embodiments, a method of network monitoring in a distributed computing environment, the method being performed by at least one processor, the method including: determining that a network monitoring request was triggered; receiving one or more parameters associated with the network monitoring request; determining computing resources available in a cluster; allocating dedicated computing resources in the cluster based on the computing resources available being insufficient; executing the network monitoring request; and displaying a result of the executed network monitoring request.

The method, according to embodiments, wherein the allocating the dedicated computing resources in the cluster may include creating a dedicated reporting queue to execute the network monitoring request.

The method, according to embodiments, wherein the creating the dedicated reporting queue to execute the network monitoring request may include allocating runtime executors based on a size of the network monitoring request.

The method, according to embodiments, wherein the network monitoring request may include a plurality of network monitoring requests, and wherein the plurality of network monitoring requests are executed simultaneously.

The method, according to embodiments, wherein the network monitoring request includes a plurality of network monitoring requests, and wherein the plurality of network monitoring requests are executed sequentially in the dedicated reporting queue.

The method, according to embodiments, wherein the network monitoring request is triggered by one of a user action using a user interface or an automatic trigger.

The method, according to embodiments, wherein the executing the network monitoring request may include determining a report type parameter from the one or more parameters associated with the network monitoring request; determining a node aggregation parameter from the one or more parameters associated with the network monitoring request, wherein the node aggregation parameter indicates one or more nodes at which aggregation functions will be performed; determining one or more key performance indicator parameters from the one or more parameters associated with the network monitoring request, wherein each of the one or more key performance indicator parameters is associated with a specific key performance indicator; and generating a network monitoring report based on the one or more parameters associated with the network monitoring request, the report type parameter, the node aggregation parameter, and the one or more key performance indicator parameters.

The method, according to embodiments, wherein the determining the one or more key performance indicator parameters includes: reading parquet files associated with each of the one or more key performance indicator parameters based on a report type being on-the-fly report; evaluating computed data associated with the each of the one or more key performance indicator parameters, wherein the computed data includes counter data associated with the each of the one or more performance indicator parameters; and computing respective key performance indicator values for the each of the one or more key performance indicator parameters based on a respective formula.

The method, according to embodiments, wherein based on a report type parameter being an exception metrics report, the displaying the result of the executed network monitoring request includes enabling a visual configuration for the each of the one or more performance indicator parameters, wherein the visual configuration indicates a level of exceptions generated.

The method, according to embodiments, wherein the displaying the result of the executed network monitoring request includes: displaying a compact view of the executed network monitoring request; and displaying a user interaction toolbar, wherein the user interaction toolbar is configured to perform one of view, preview, edit, copy, download, subscribe, or delete operations.

The method, according to embodiments, wherein subsequent to the executing the network monitoring request, the method further comprises storing the executed network monitoring request in a repository in a distributed file system of the distributed computing environment.

According to embodiments, a non-transitory computer-readable medium stores instructions including: one or more instructions that, when executed by one or more processors of a device for automatic troubleshooting, cause the one or more processors to: determine that a network monitoring request was triggered; receive one or more parameters associated with the network monitoring request; determine computing resources available in a cluster; allocate dedicated computing resources in the cluster based on the computing resources available being insufficient; execute the network monitoring request; and display a result of the executed network monitoring request.

According to embodiments, an apparatus for network monitoring in a distributed computing environment, the apparatus comprising: a memory configured to store instructions; and one or more processors configured to execute the instructions to: determine that a network monitoring request was triggered; receive one or more parameters associated with the network monitoring request; determine computing resources available in a cluster; allocate dedicated computing resources in the cluster based on the computing resources available being insufficient; execute the network monitoring request; and display a result of the executed network monitoring request.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a flowchart of an example process for network monitoring of a telecommunication system in a distributed computing environment, according to embodiments;

FIG. 2 is a diagram of an example environment in which systems and/or methods, described herein, may be implemented, according to embodiments;

FIG. 3 is a diagram of example components of one or more devices of FIG. 2, according to embodiments; and

FIG. 4 is an example workflow diagram for network monitoring, according to embodiments;

FIG. 5 is an example workflow diagram for network monitoring, according to embodiments;

FIG. 6 is a flow chart of an example process for network monitoring, according to embodiments.

FIG. 7 is a flow chart of an example process for network monitoring, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

As is traditional in the field, embodiments may be described and illustrated in terms of blocks which carry out a described function or functions. These blocks, which may be referred to herein as units or modules or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including.” or the like are intended to be open-ended terms. Further, the phrase “based on” is intended to mean “based, at least in part, on” unless explicitly stated otherwise.

Embodiments relate to generating network monitoring reports, including reports on all network equipment, all domains, all vendors, and technologies. By generating network monitoring reports, especially network monitoring reports that include granularity on various geographical levels, times, duration, subset of network elements, etc., monitoring of network infrastructure because more efficient, resulting in better use of network resources.

Embodiments also relate to generating network monitoring reports using dedicated computing resources or dedicated queues in a distributed computing systems (e.g., Hadoop, Spark, etc.). Sometimes, depending on the nature and granularity of the network monitoring report needed, generating the network monitoring report may take too much time or may need more resources that available. This delay in generating the network monitoring report may result in loss of network elements or services and potentially lead to loss of revenue. Thus, to ensure that network monitoring reports are timely generated, embodiments of the present disclosure relate to allocating dedicated computing resources for generating network monitoring reports. For example, in a distributed computing system, a specific queue or a specific cluster may be used to generate network monitoring reports. The use of dedicated computing resources for network monitoring results in a reduction in report generating time, reduction in time needed to identify a potential network problem using the network monitoring report, and better overall management of the telecommunications network.

Further, allocating a dedicated queue or allocating dedicated computing resources will also result in reduced memory storage requirements and efficient utilization of computing resources. In related art, network monitoring reports may be generated through specific codes that enable the generation of only one monitoring report at the time. The allocation of resources such as dedicated clusters or dedicated queues may enable generation of multiple network monitoring reports simultaneously or in parallel.

Using embodiments described herein, a network monitoring report may be generated much faster and more accurate. Also, the risk of an extended or long-term network equipment issue may be reduced, as embodiments may generate network monitoring reports much more quickly than traditional related-art procedures. Embodiments may allow human involvement to be reduced by providing customization and templating features to generate new network monitoring reports without the need to add a new code for it. In addition, embodiments may provide an analytics capability, where we can identify network's problems and work on it for improvement without human intervention. By doing so, operation cost in the telecommunication industry may be reduced and auto-healing functionality may be provided. Accordingly, embodiments may provide network monitoring through dynamic generation of network monitoring reports and dynamic allocation of resources. In addition, embodiments may provide faster identification of issues, operating expenses (opex) cost reduction, major incident avoidance, and increased customer satisfaction.

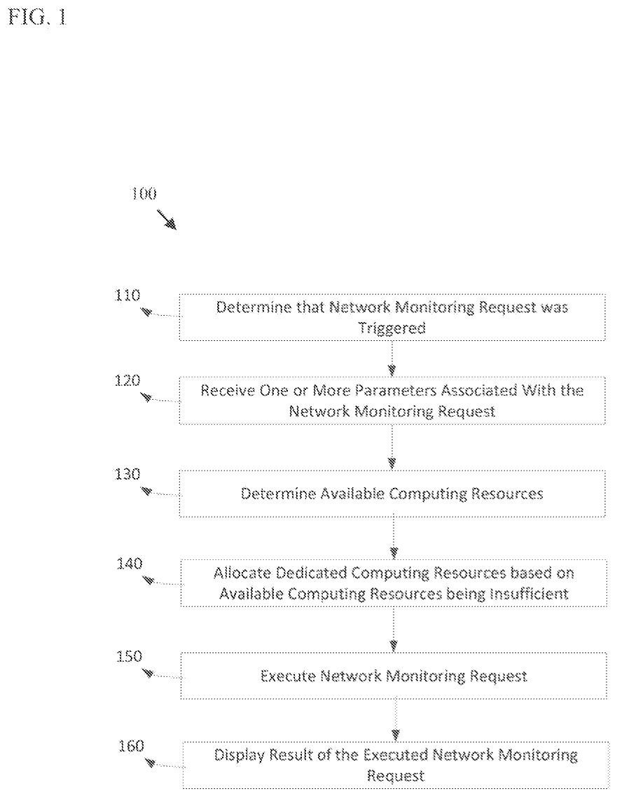

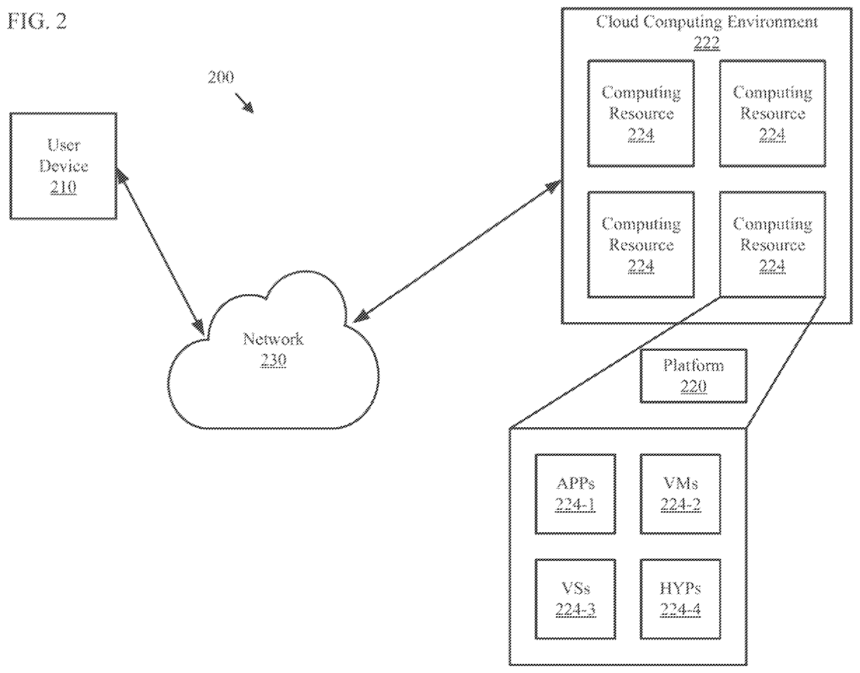

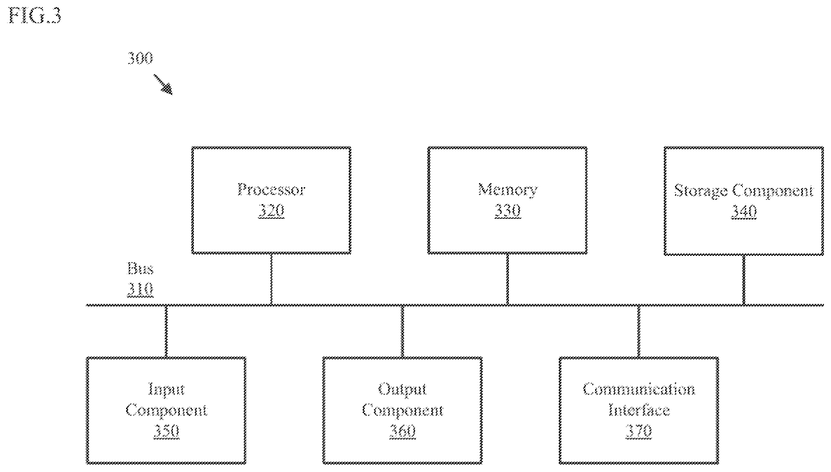

FIG. 1 is a flow chart of an example process 100 for network monitoring in a distributed computing environment. As illustrated in FIG. 1, one or more process blocks of operations may be performed by any of the elements of FIGS. 2-3 discussed herein.

As illustrated in FIG. 1, one or more process blocks of process 100 may correspond to network monitoring and management. In some embodiments, one or more process blocks of process 100 may be performed by or using elements illustrated in FIGS. 2-3, for example any one or more of user device 210, platform 220, computing resource 224, or components of device 300.

Process 100 may represent one process flow out of many process flow. The process flow illustrated in process 100 that may be used to generate one particular network monitoring report out of many possible network monitoring reports. For example, process 100 may be used to generate a network monitoring report “on-the-fly” to aggregate and analyze exceptions generated at various network elements.

As shown in FIG. 1, process 100 may include an operation 110 for determining that a network monitoring request was triggered. According to embodiments of the present disclosure, a network monitoring request may be received from a user or may be generated automatically. In embodiments, the network monitoring request may be triggered by a user action using a user interface. In some embodiments, the network monitoring request may be triggered by an automatic trigger. As an example, in some embodiments, the network monitoring request may be triggered using the user device 210.

In some embodiments, the network monitoring request may be triggered automatically. As an example, the network monitoring request may be triggered automatically hourly, weekly, monthly, or quarterly basis. In some embodiments, the network monitoring request may be triggered based on a user input using a user interface. As an example, the network monitoring request may be triggered in real-time based on a user's request using a form, a user interface, or through and application programming interface.

As shown in FIG. 1, process 100 may include an operation 120 for receiving one or more parameters associated with the network monitoring request.

A network monitoring request may include one or more parameters, each of the one or more parameters corresponding to a field in the network monitoring report. The one or more parameters included in the network monitoring request may also be referred to as network monitoring request configuration details because they guide the configuration of the network monitoring report.

As an example, the network monitoring request may include a first parameter of the one or more parameters that indicates a report type of the network monitoring request. The first parameter may be referred to as the report type in the present disclosure. The report type may indicate the other parameters may be included in the network monitoring request. The report type may be used to determine the database from which data corresponding to the network monitoring request may be obtained. According to embodiments, the report type being one of key performance indicator (KPI) report, exception metrics report, custom aggregation report, or trend report, at least a part of the data associated with the network monitoring request may be obtained from a structured database. As an example, data may be obtained from a structured database such as an SQL-based database. According to embodiments, the report type being on-the-fly (OTF) type, at least a part of the data associated with the network monitoring request may be obtained from an unstructured database. As an example, data may be obtained from an unstructured database such as HBase in the Hadoop® framework.

According to embodiments, the network monitoring request may include a second parameter of the one or more parameters that indicates a selection of one or more key performance indicator parameters. The key performance indicators may also be referred to as key performance indicators (KPIs). The selection of performance indicators may include a group of two or more key performance indicators. In some embodiments, the selection of performance indicators may include a customized group of two or more key performance indicators or a group of user defined key performance indicators.

In some embodiments, based on the report type, data associated with the selected key performance indicators may be obtained by reading parquet files associated with each of the one or more key performance indicator parameters. Parquet files may be files used for columnar storage. Parquet files may be used for processing data in the Hadoop framework systems such as Pig, Spark, and Hive. In some embodiments, some of the one or more key performance indicator parameters may include a sub-key performance indicators or a counter.

According to embodiments of the present disclosure, key performance indicators may include, but may not be limited to the following key performance indicators total subscribers, chum per month, usage, minutes of usage, minutes carried per month, airtime capacity utilization, minutes per site, average revenue per user (ARPU), ARPU segmentation, average revenue per call, coverage and spread, towns covered, population covered, area covered, number ofBTS sites, number of MSC sites, MSC/Subscribers, MSC/BTS BTS/Subscribers (1000), BTS/Km², Capex, Opex, OSS/BSS Ratio, quality, service performance, RTT delay, application throughput, call setup time, network congestions, point of interconnection congestion, call setup success rate, standalone dedicated control channel (SDCCH) congestion, connection maintenance (Retainability), call drop rate (CDR), worst affected cells for call drop rate, connection with good voice quality, handover success rate, network availability, BTSs accumulated downtime, worst affected BTSs due to downtime, energy consumption/subscriber, CO2 emission/subscriber, tenancy ratio, spectrum efficiency, busy hour mErlangs carried/sq km/per MHz, busy hour mErlangs per subscriber, Subscribers/Km2/MHz, Subscribers/Km2 (Urban), Spectrum per Operator (MHz), etc. According to embodiments of the present disclosure, key performance indicators may include, but may not be limited to key performance indicators such as average users connected, average downlink or uplink physical resource block utilization, uptime, network jitter, packet loss, latency, signal strength, average user session time, throughput, partial cell availability, handover preparation & execution, etc.

According to embodiments, the network monitoring request may include a third parameter of the one or more parameters that indicates a selection of one or more nodes or network elements based on which aggregation functions may be performed. As an example, the network monitoring request may include one or more nodes including a specific node, a group of nodes of a particular type, or a group of nodes in a particular geographic region. According to some embodiments, network monitoring request may include a customized list of nodes, wherein the list may be user defined list of specific network elements.

According to embodiments, the network monitoring request may also include one or more of the following parameters or network monitoring request configuration details.

| Parameter | |
|---|---|
| Name | Description |
| Name | The name of the performance report. |
| Report Type | The type of the performance report. May include key |
| | performance indicator (KPI) report, exception metrics |
| | report, custom aggregation report, trend report, or |
| | on-the-fly (OTF) report. |
| Domain | The domain of the performance report. Domain may be |
| | the area of working for example RAN, Core, Transport, |
| | Infra and so on. |
| Technology | The technology of the performance report. Technologies |
| | may include type of telecom networks such as GSM, |
| | CDMA, etc. and may also include generations of |
| | telecommunication networks including 2G, 3G, 4G, 5G, |
| | etc. |
| Vendor | The vendor of the network elements to include in |
| | the performance report. Vendor may include network |
| | equipment/element supplier like Nokia, Ericsson, etc. |
| Node | The node or nodes at which the node aggregation |
| | may take place. Node may be a communication |
| | endpoint in telecommunication network also known |
| | as Network Element (NE) |
| Duration | The selected duration for the performance report |
| Time | The selected for the performance report |
| Level | The level of the performance report. May include |
| | levels indicative of access for access control or |
| | may include granularity levels for the one or more |
| | parameters |
| Geographic | The geographic granularity selected for the performance |
| Level | report. |
| Created Date | The date at which a selected KPI was created |
| Modified | The date at which a selected KPI was last modified |
| Date | |
| Created By | The name of the person who created or defined the |
| | selected KPI |
| Modified By | The name of the person who last modified the selected KPI |

As shown in FIG. 1, process 100 may include an operation 130 for determining available computing resources. According to embodiments of the present disclosure, the process 100, or the operations therein may be implemented using distributed processing engine such as Apache Spark® (hereinafter Spark). Before executing any tasks or jobs, the distributed processing engine may communicate with a cluster manager to determine the available resources for executing the task or job. If the task or job requires more memory or computing power that currently available at a cluster in the distributed computing system, that task or job may be queued for a later time at which the required resources may be available. In some embodiments, determining the available computing resources may depend on the memory or computational requirements of the network generating request or a potential size of a network monitoring report. In embodiments, the memory or computational requirements of the network generating request (in some embodiments, referred to as a size of the network monitoring request) may be based on the amount, location, and processing associated with the data associated with the identified parameters associated with the network monitoring request. As an example, the memory or computational requirements of the network generating request may be higher when the data required to execute the network monitoring request or generate the network monitoring report is stored in different locations such as a structured database and an unstructured database. As another example, if the data to be read needs parsing or processing, e.g., reading parquet files, the memory or computational requirements of the network generating request may be higher. When the memory or computational requirements of the network generating request may be higher than what is available in a cluster, it may be determined that the computing resources available may be insufficient.

As shown in FIG. 1, process 100 may include an operation 140 for allocating dedicated computing resources to execute the network monitoring request. In some embodiments, the allocating of the dedicated computing resources in the cluster may include creating a dedicated reporting or processing queue to execute the network monitoring request. In some embodiments, the allocating the dedicated computing resources in the cluster may include dedicating memory space in the cluster to execute the network monitoring request. In some embodiments, the allocating the dedicated computing resources in the cluster may include dedicating a computer node in the cluster to execute the network monitoring request. In some embodiments, creating of the dedicated reporting or processing queue or dedicating a computer node in the cluster to execute the network monitoring request may include allocating runtime executors based on a size of the network monitoring request. As an example, Apache Spark Context® may use cluster manager and runtime executors associated with worker nodes to dedicate a queue for report generation. Dedicating computing resources will reduce report generation time and improve efficient memory use. In some embodiments, the network monitoring request may include a plurality of network monitoring requests. Based on the dedicated resources, the plurality of network monitoring requests may be executed simultaneously or in parallel.

As shown in FIG. 1, process 100 may include an operation 150 for executing the network monitoring request. The executing of the network monitoring request generates the network monitoring report that includes all the requested information to enable efficient network monitoring.

In some embodiments, executing the network monitoring request includes determining a report type parameter from the one or more parameters associated with the network monitoring request. As an example, the network monitoring request may include a parameter indicating a report type of the network monitoring request. The report type may also indicate the other parameters may be included in the network monitoring request. The report type may be used to determine the database from which data corresponding to the network monitoring request may be obtained, the structure of the report, and the access level of the report. According to embodiments, when the report type may be one of key performance indicator (KPI) report, exception metrics report, custom aggregation report, or trend report, at least a part of the data associated with the network monitoring request may be obtained from a structured database. As an example, data may be obtained from a structured database such as an SQL-based database. According to embodiments, when the report type may be on-the-fly (OTF) type, at least a part of the data associated with the network monitoring request may be obtained from an unstructured database. As an example, data may be obtained from an unstructured database such as HBase in the Hadoop® framework.

In some embodiments, executing the network monitoring request includes determining a node aggregation parameter from the one or more parameters associated with the network monitoring request, wherein the node aggregation parameter indicates one or more nodes at which aggregation functions will be performed.

In some embodiments, executing the network monitoring request includes determining one or more key performance indicator parameters from the one or more parameters associated with the network monitoring request, wherein each of the one or more performance indicator parameters is associated with a specific key performance indicator. According to embodiments, the network monitoring request may include a selection of one or more key performance indicator parameters. The key performance indicators may also be referred to as key performance indicators (KPIs). The selection of key performance indicators may include a group of two or more key performance indicators. In some embodiments, the selection of performance indicators may include a customized group of two or more key performance indicators or a group of user defined key performance indicators.

In some embodiments, the determining the one or more key performance indicator parameters includes reading parquet files associated with each of the one or more key performance indicator parameters. In some embodiments, based on the report type, data associated with the selected key performance indicators may be obtained by reading parquet files associated with each of the one or more key performance indicator parameters. Parquet files may be files used for columnar storage. Parquet files may be used for processing data in the Hadoop framework systems such as Pig, Spark, and Hive.

In some embodiments, the determining the one or more key performance indicator parameters includes evaluating computed data associated with the each of the one or more key performance indicator parameters, wherein the computed data includes counter data associated with the each of the one or more performance indicator parameters. A sub-key performance indicator or a counter may keep count or keep track of a value associated with the key performance indicator. Including respective sub-key performance indicators or counters allows more flexibility in interpreting respective key performance indicators and may also be used a threshold to interpret the key performance indicators.

In some embodiments, the determining the one or more key performance indicator parameters includes computing respective key performance indicator values for the each of the one or more key performance indicator parameters based on a respective formula. In some embodiments, the formulae may be pre-defined. In some embodiments, the formulae may be user defined. Further, based on the node aggregation parameter, in some embodiments, computing the respective key performance indicator values for the each of the one or more key performance indicator parameters may be based on the respective formula with respect to the nodes or network elements in the nodes aggregation parameter.

In some embodiments, executing the network monitoring request includes generating a network monitoring report based on the one or more parameters associated with the network monitoring request, the report type parameter, the node aggregation parameter, and the one or more key performance indicator parameters. As an example, data associated from the one or more parameters may be read from one or more databases, filtered, and processed based on the report type, the node aggregation parameter, and the one or more key performance indicator parameters. In the present disclosure, executed network monitoring request may be referred to as the generated network monitoring report.

The generated network monitoring report may be generated in a plurality of format types, such as, comma separated files. In some embodiments, the generated network monitoring report may be sent over email. Further, in some embodiments, the generated network monitoring reports may be grouped in a folder structure, and may support previews of the reports.

As shown in FIG. 1, process 100 may include an operation 160 for displaying the results of the executed network monitoring request.

According to embodiments of the present disclosures, the generated network monitoring report may be displayed on a user interface of a user device 210. In some embodiments, a compact view of the generated network monitoring report may be displayed in some embodiments, in addition to the compact view, a user interaction toolbar may be displayed, wherein the user interaction toolbar may be configured to perform one of view, preview, edit, copy, download, subscribe, clone, or delete operations on the generated network monitoring report.

In some embodiments, the structure of the report, including row headers or column headers may be customized. As an example, the order in which the parameters included in the network monitoring request or included in the network monitoring report may be customized. In some embodiments, headers may be disabled or enabled. In some embodiments, when the report type is a trend report, the displaying the result of the executed network monitoring request may include the headers being row headers.

In some embodiments, when the report type may be an exception metrics report the displaying the result of the executed network monitoring request may include enabling a visual configuration for the each of the one or more performance indicator parameters.

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions of the elements included in network monitoring system 100 may be performed by any combination of elements illustrated in FIG. 2. For example, in embodiments, user device 210 may perform one or more functions associated with user device 106, and platform 220 may perform one or more functions associated with any of degradation trigger module 102, procedure identification module 104, correlation module 106, matching module 108, or new anomaly identification module 110.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 is not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”) A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In embodiments, any one of the operations or processes of FIG. 1 may be implemented by or using any one of the elements illustrated in FIGS. 2-3.

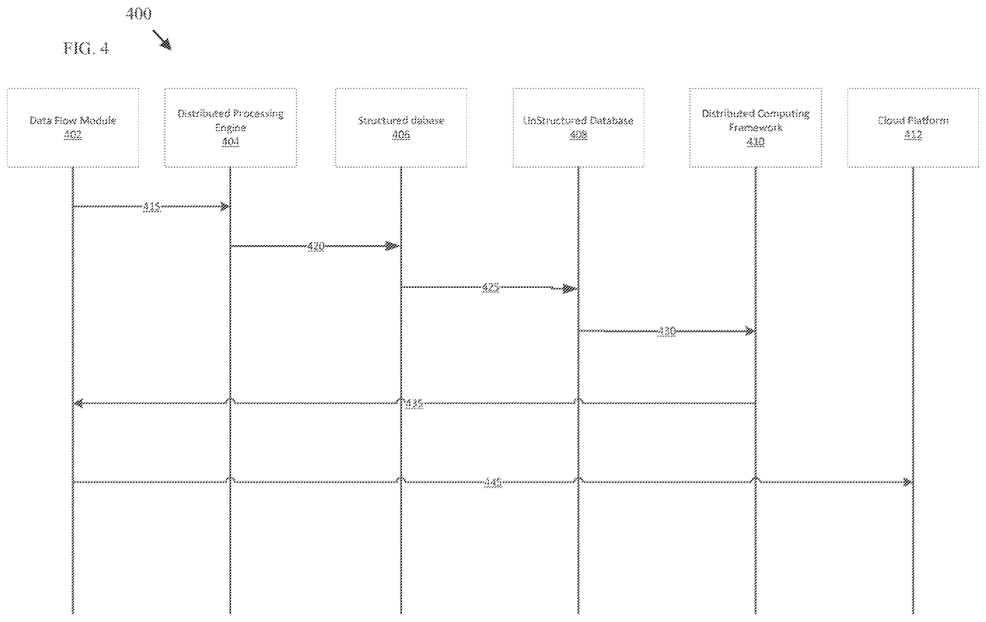

FIG. 4 is an exemplary workflow diagram illustrating a workflow 400 in which systems and/or methods, described herein, may be implemented. As shown in FIG. 4, the workflow 400 may be used to execute the network monitoring request to generate the network monitoring report in a distributed computing environment.

In some embodiments, workflow 400 may illustrate the workflow used to execute the network monitoring request to generate the network monitoring report in a distributed computing environment based on the report type being a key performance indicator report, an exception metrics report, or a custom aggregation report.

Referring to FIG. 4, at operation 415, a network monitoring request trigger may be generated through a data flow module 402 that enables data transfer between systems to request a network monitoring report. A data flow module 402 may act as a module that automates and manages data flow between multiple systems. In some embodiments, the data flow module 402 may be graph based to enable data routing between disparate systems. As an example, a data flow module 402 may be implemented using Apache NiFi™ or similar data flow software. In some embodiments, the data flow module 402 may generate the network monitoring request trigger automatically at pre-defined time intervals or based on a user action through a user interface. In some embodiments, a user may manually request the generation of the network monitoring request trigger using an application programming interface. In some embodiments, artificial intelligence and machine learning methods may be used to determine optimal times to generate the network monitoring request trigger to execute the network monitoring request to generate the network monitoring report in a distributed computing environment.

At operation 420, the generated network monitoring request trigger 415 may cause a distributed processing engine 404 (e.g., Spark™) to read data corresponding with some of the parameters associated with the network monitoring request from a structured database 406. (e.g., MySQL™). As an example, the distributed processing engine 404 may read data corresponding to some of the parameters associated with the network monitoring request such as report type, domain, technology, vendor, node, duration, time, level, geography level, etc., from the structured database 406.

At operation 425, the generated network monitoring request trigger may cause a distributed processing engine 404 or the structured database 406 to read other data corresponding with some of the parameters associated with some of the network monitoring request from an unstructured database 408 (e.g., HBase™). As an example, the distributed processing engine 404 or the structured database 406 may read other data corresponding with some of the parameters associated with network monitoring request that may not be available in the structured database 406.

In some embodiments, operation 420 and operation 425 may be performed using dedicated computing resources in a cluster of the distributed computing framework 410 or on a dedicated reporting queue on the distributed processing engine 404. In some embodiments, creating a dedicated reporting queue may include allocating runtime executors based on a size of the network monitoring request.

At operation 430, the data read using operations 420 and 425 may be converted into a network monitoring report as a comma separated values file and stored the distributed computing framework 410. In some embodiments, the network monitoring report may be stored in the distributed computing framework 410 like a Hadoop® framework. As an example, the generated network monitoring report may be stored on the Hadoop Distributed File System (HDFS) or on Spark SQL in the Hadoop® environment.

At operation 435, the flow file associated with the generated network monitoring report may be transmitted to the data flow module 402. In some embodiments, the data flow module 402 may transfer the generated network monitoring report to one or more systems that display the generated network monitoring report. As an example, the generated network monitoring report may be transmitted to a software like Apache NiFi™ which in turn may transmit the generated network monitoring report for display on a user device like user device 210.

At operation 445, the generated network monitoring report may be stored on a server or a cloud platform 412. The cloud platform 412 may be a Platform as a Service (PaaS) model providing hosting services. REST APIs, and back-end services for mobile applications. Using a user interface and/or a user device, cloud platform 412 may retrieve the network monitoring report from the distributed computing framework 410. Structured database 406 and unstructured database 408 may be implemented as a cloud-based server. Examples of cloud based database servers may include, but are not limited to, Hadoop®, MongoDB®, MySQL®, NoSQL®, and Oracle®.

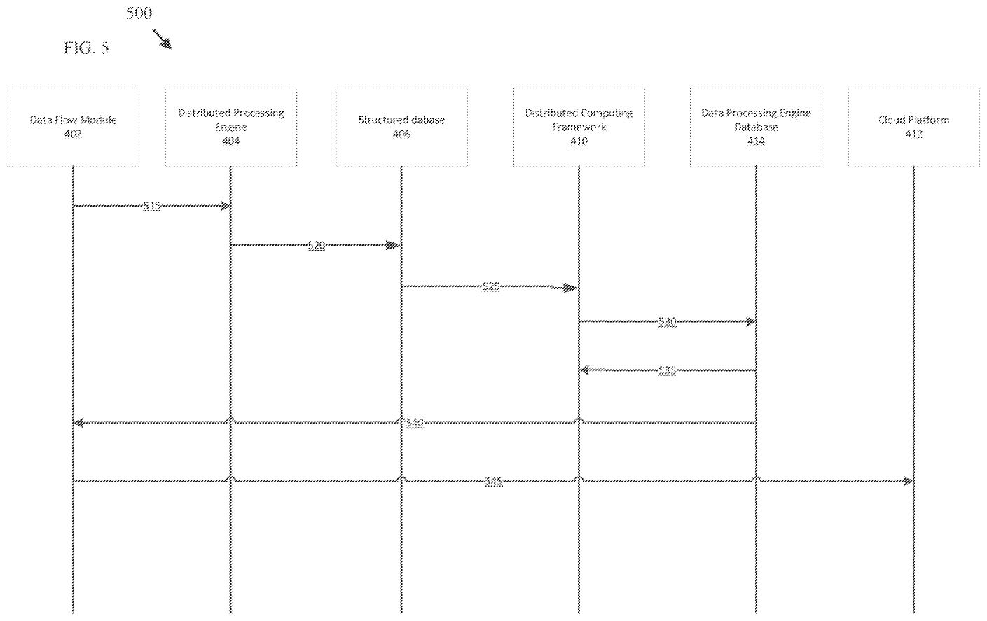

FIG. 5 is an exemplary workflow diagram illustrating a workflow 500 in which systems and/or methods, described herein, may be implemented. As shown in FIG. 5, the workflow 500 may be used to execute the network monitoring request to generate the network monitoring report in a distributed computing environment.

In some embodiments, workflow 500 may illustrate the workflow used to execute the network monitoring request to generate the network monitoring report in a distributed computing environment based on the report type being an on-the-fly report.

Referring to FIG. 5, At operation 515, a network monitoring request trigger may be generated through a data flow module 402 that enables data transfer between systems to request a network monitoring report. A data flow module 402 may act as a module that automates and manages data flow between multiple systems. In some embodiments, the data flow module 402 may be graph based to enable data routing between disparate systems. As an example, a data flow module 402 may be implemented using Apache NiFi™ or similar data flow software. In some embodiments, the data flow module 402 may generate the network monitoring request trigger automatically at pre-defined time intervals or based on a user action through a user interface. In some embodiments, a user may manually request the generation of the network monitoring request trigger using an application programming interface. In some embodiments, artificial intelligence and machine learning methods may be used to determine optimal times to generate the network monitoring request trigger to execute the network monitoring request to generate the network monitoring report in a distributed computing environment.

At operation 520, the generated network monitoring request trigger may cause a distributed processing engine 404 (e.g., Spark™) to read data corresponding with some of the parameters associated with the network monitoring request from a structured database 406. (e.g., MySQL™). As an example, the distributed processing engine 404 may read data corresponding to some of the parameters associated with the network monitoring request such as report type, domain, technology, vendor, node, duration, time, level, geography level, etc., from the structured database 406.

At operation 525, the generated network monitoring request trigger 515 may cause a distributed processing engine 404 or the structured database 406 to read parquet files associated with key performance indicators that indicate the performance of the telecommunications network. As stated throughout the present disclosure, in some embodiments, one or more parameters may be associated with the network monitoring request. One or more key performance indicator parameters may be included in the one or more parameters may be associated with the network monitoring request. Real-time data associated with the one or more key performance indicator parameters may be stored as a parquet file on the distributed computing framework 410. This real-time key performance indicator data may need to be read from the data processing engine database 414 to include information about the one or more key performance indicator parameters in the generated network monitoring report.

At operation 530, computed counter data associated with the each of the one or more performance indicator parameters may be evaluated, a key performance indicator value may be calculated for the each of the one or more performance indicator parameters based on a respective formula, and stored on a data processing engine database 414 (e.g., Spark Database) In some embodiments, the computed counter data and the key performance indicator values may be stored on any of the storage databases or devices described in the present disclosure.

At operation 535, the data read, evaluated, and calculated using operations 515, 520, 525, and 530 may be converted into a network monitoring report as a comma separated values file and stored the distributed computing framework 410. In some embodiments, the network monitoring report may be stored in the distributed computing framework 410 like a Hadoop® framework. As an example, the generated network monitoring report may be stored on the Hadoop Distributed File System (HDFS) or on Spark SQL in the Hadoop® environment.

In some embodiments, operation 520, 525, 530, and 535 may be performed using dedicated computing resources in a cluster of the distributed computing platform 410 or on a dedicated reporting queue on the distributed processing engine 404. In some embodiments, creating a dedicated reporting queue may include allocating runtime executors based on a size of the network monitoring request.

At operation 540, the flow file associated with the generated network monitoring report may be transmitted to the data flow module 402. In some embodiments, the data flow module 402 may transfer the generated network monitoring report to one or more systems that display the generated network monitoring report. As an example, the generated network monitoring report may be transmitted to a software like Apache NiFi™ which in turn may transmit the generated network monitoring report for display on a user device like user device 210.

At operation 545, the generated network monitoring report may be stored on a server or a cloud platform 412. The cloud platform 412 may be a Platform as a Service (PaaS) model providing hosting services, REST APIs, and back-end services for mobile applications. Using a user interface and/or a user device, cloud platform 412 may retrieve the network monitoring report from the distributed computing framework 410. Structured database 406 and unstructured database 408 may be implemented as a cloud-based server. Examples of cloud based database servers may include, but are not limited to, Hadoop®, MongoDB®, MySQL®, NoSQL®, and Oracle®.

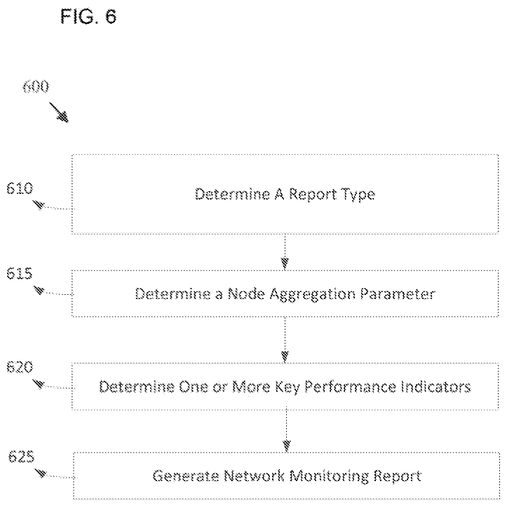

FIG. 6 is a flow chart of an example process 600 for executing the network monitoring request and generating a network monitoring report in a distributed computing environment. As illustrated in FIG. 6, one or more process blocks of operations may be performed by any of the elements of FIGS. 2-3 discussed herein.

As illustrated in FIG. 6, one or more process blocks of process 600 may correspond to network monitoring and management. In some embodiments, one or more process blocks of process 100 may be performed by or using elements illustrated in FIGS. 2-3, for example any one or more of user device 210, platform 220, computing resource 224, or components of device 300.

Process 600 may represent one process flow out of many process flow. The process flow illustrated in process 600 that may be used to generate one particular network monitoring report out of many possible network monitoring reports. For example, process 600 may be used to generate a network monitoring report to aggregate and analyze key performance indicators trends across one or more network elements.

At operation 610, a report type from the one or more parameters associated with the network monitoring request may be determined.

At operation 615, a node aggregation parameter from the one or more parameters associated with the network monitoring request may be determined. The node aggregation parameter indicates one or more nodes at which aggregation functions will be performed.

At operation 620, one or more key performance indicator parameters from the one or more parameters associated with the network monitoring request may be determined. The each of the one or more performance indicator parameters may be associated with a specific key performance indicator.

At operation 625, the network monitoring report may be generated. The generated network monitoring report may be based on the one or more parameters associated with the network monitoring request, the report type parameter, the node aggregation parameter, and the one or more key performance indicator parameters. As an example, data associated from the one or more parameters may be read from one or more databases, filtered, and processed based on the report type, the node aggregation parameter, and the one or more key performance indicator parameters.

According to embodiments of the present disclosure, data associated with each of the one or more key performance indicator parameters may be read from parquet files. Further, computed data including counter data associated with the each of the one or more key performance indicator parameters may be evaluated, and respective key performance indicator values for the each of the one or more key performance indicator parameters may be calculated based on a respective formula.

In some embodiments, one or more process blocks of process 600 may be performed by or using elements illustrated in FIGS. 2-3, for example any one or more of user device 210, platform 220, computing resource 224, or components of device 300.

In some embodiments, one or more process blocks of process 600 may be performed using dedicated computing resources in a cluster of the distributed computing framework 410 or on a dedicated reporting queue on the distributed processing engine 404. In some embodiments, creating a dedicated reporting queue may include allocating runtime executors based on a size of the network monitoring request.

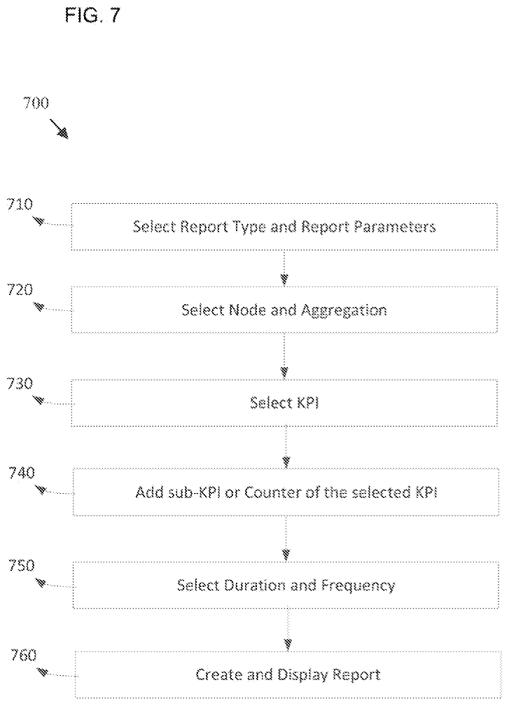

FIG. 7 is a flow chart of an example process 700 for generating a network monitoring request and based on the network monitoring request, generating a network monitoring report in a distributed computing environment. According to embodiments, a network monitoring request may be received from a user interface on a device, from an authorized user using an application programming interface, or may be generated automatically or periodically. The generation of the network monitoring request may be used to trigger process 100 to generate a network monitoring report based on the network monitoring request.

As illustrated in FIG. 7, one or more process blocks of operations may be performed by any of the elements of FIGS. 2-3 discussed herein. As illustrated in FIG. 7, one or more process blocks of process 700 may correspond to receiving or generating the network monitoring request. In some embodiments, one or more process blocks of process 700 may be performed by or using elements illustrated in FIGS. 2-3, for example any one or more of user device 210, platform 220, computing resource 224, or components of device 300. At operation 710, a report type and other report parameters may be selected.

In some embodiments, a user may initiate process 700. Customized parameters may be selected to generate the network monitoring request, the customized parameters may include the one or more parameters as described herein. Further, one or more key performance indicators may be selected based on the network monitoring report that a user may want to generate. Lastly, the frequency and date ranges for the network monitoring report may be selected. Thus, in some embodiments, the generation of the network monitoring request may include three steps, the steps including selecting the type of report and nodes, selecting one or more key performance indicators, and selecting the duration and frequency of the reports.

At operation 710, parameters associated with the network monitoring request including report type may be selected including a report type. As an example, a report type from a key performance indicator report, an exception metrics report, a custom aggregation report, a trend report, or an on-the-fly report may be selected. In some embodiments, a scheduled report type may also be selected. In some embodiments, a user may select one or more parameters associated with a network monitoring request through a user interface. As an example, a user may select parameters associated with the network monitoring request such as report type, domain, technology, vendor, node, duration, time, level, geography level, etc. through a user interface on user device 210. In some embodiments, initially, only report type, mode, domain, technology, and vendor.

At operation 720, one or more nodes may be selected for node aggregation. The one or more selected nodes may be the nodes at which the aggregation functions are executed, i.e., key performance indicators are calculated with respect to each node selected or the selected nodes as a group. In some embodiments, based on the report type being key performance indicator report, exception metric report, or on-the-fly report, additional parameters including report level, report access, country level, radio manager, optimizer, beacon chunk, site status, and cell owners, etc. may also be selected along with the nodes at which the aggregation functions are executed. As another example, in embodiments where the report type may be custom aggregation report, additional parameters including templates and cell owners may be selected along with the nodes at which the aggregation functions are executed.

In some embodiments, the one or more selected nodes at which the aggregation functions are executed may be uploaded as a list of nodes. The list of nodes may include a list of nodes from a drop-down list, from a file (e.g., a .csv file), a pre-selected list or group used prior, or all the nodes in a geographic area. One or more nodes from the list of nodes may be deleted to customize further customize node selection.

At operation 730, key performance indicators to be used in the network monitoring report may be selected. The selected key performance indicators may be selected based on the purpose of the network monitoring report. As an example, a network monitoring report specifically intended to determine exceptions generated in a specific geographic area may include key performance indicators such as handover success rate, network congestion, etc., within the nodes or network elements in that specific geographic area.

In some embodiments, the one or more selected key performance indicators may be uploaded as a list of key performance indicators. The list of key performance indicators may include a list of key performance indicators mentioned throughout the disclosure from a drag-and-drop menu, a drop-down list, from a file (e.g., a .csv file), a pre-selected list or group used prior, or on the basis of selected domains, vendors, and technologies. One or more key performance indicators from the list or pre-defined group of key performance indicators may be deleted to further customize key performance indicators selection. Further, in some embodiments, a group of key performance indicators may be created by manually selecting the key performance indicators and adding them to a new or existing group. In some embodiments, a group of pre-selected key performance indicators may display existing key performance indicators in that group. In some embodiments, the key performance indicators may be selected by searching the available key performance indicators.

At operation 740, sub-key performance indicators or counters may be added. A sub-key performance indicator or a counter may keep count or keep track of a value associated with the key performance indicator. Including respective sub-key performance indicators or counters allows more flexibility in interpreting respective key performance indicators and may also be used a threshold to interpret the key performance indicators. For example, in some embodiments, a visual configuration indicative of a level of key performance indicators or sub-key performance indicators may be used to display the generated network monitoring report. As an example a red-amber-green (RAG) visual configuration may be used to help interpret key performance indicators by defining conditions that help interpret the values of the key performance indicators or the sub-key performance indicators. In some embodiments, based on a report type parameter being an exception metrics report, the displaying the executed network monitoring request may include enabling a visual configuration for the each of the one or more performance indicator parameters, wherein the visual configuration may indicate a level of exceptions generated.

At operation 750, duration and frequency for network monitoring report may be generated. A start duration, a start time, an end duration, and an end time may be selected indicating the active time for which the network monitoring may be performed and network monitoring report may be generated. According to embodiments, a frequency may indicate the frequency with the network monitoring report may be generated. As an example, a specific network monitoring report may be generated every day, every week, every month, every hour, busy day, etc. In some embodiments, instead of a frequency or a duration, the network monitoring may be performed and network monitoring report may be generated for a specific date. Ability to perform network monitoring and generate network monitoring report on custom days at custom times enables real-time monitoring of the network elements in the telecommunication, enhancing efficiency, reducing costs, enabling better customer service.

At operation 760, the generated network monitoring report may be generated and displayed. Subsequent to selecting parameters associated with the network monitoring request, the network monitoring report may be generated. In some embodiments, the network monitoring report may be generated based on the one or more parameters associated with the network monitoring request, the report type, the node aggregation, and the one or more key performance indicators selected.

According to embodiments of the present disclosures, the generated network monitoring report may be displayed on a user interface of a user device 210. In some embodiments, a compact view of the generated network monitoring report may be displayed in some embodiments, in addition to the compact view, a user interaction toolbar may be displayed, wherein the user interaction toolbar may be configured to perform one of view, preview, edit, copy, download, subscribe, clone, or delete operations on the generated network monitoring report.

In some embodiments, the structure of the report, including row headers or column headers may be customized. As an example, the order in which the parameters included in the network monitoring request or included in the network monitoring report may be customized. In some embodiments, headers may be disabled or enabled.

In some embodiments, subsequent to generating and displaying the network monitoring report, the executed network monitoring request or generated network monitoring report may be stored in a database. As an example, the reports may be stored in a repository such as in a distributed file system of the distributed computing environment.

Although FIGS. 1, 6, and 7 shows example blocks of process 100, 600, and 700, in some implementations, processes 100, 600, and 700, may include additional blocks, fewer blocks, different blocks, or differently arranged blocks than those depicted in FIGS. 1, 6, and 7. In embodiments, one or more blocks of example blocks of process 100, 600, and 700, may be combined or arranged in any order or amount. In embodiments, two or more of the blocks of processes 100, 600, and 700, may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of network monitoring in a distributed computing environment, the method being performed by at least one processor, the method comprising:
determining that a network monitoring request was triggered;
receiving one or more parameters associated with the network monitoring request;
determining computing resources available in a cluster;
allocating dedicated computing resources in the cluster based on the computing resources available being insufficient;
executing the network monitoring request; and
displaying a result of the executed network monitoring request.

2. The method of claim 1, wherein the allocating the dedicated computing resources in the cluster comprises creating a dedicated reporting queue to execute the network monitoring request.

3. The method of claim 2, wherein the creating the dedicated reporting queue to execute the network monitoring request comprises allocating runtime executors based on a size of the network monitoring request.

4. The method of claim 1, wherein the network monitoring request includes a plurality of network monitoring requests, and wherein the plurality of network monitoring requests are executed simultaneously.

5. The method of claim 2, wherein the network monitoring request includes a plurality of network monitoring requests, and wherein the plurality of network monitoring requests are executed sequentially in the dedicated reporting queue.

6. The method of claim 1, wherein the network monitoring request is triggered by one of: a user action using a user interface or an automatic trigger.

7. The method of claim 1, wherein the executing the network monitoring request comprises:
determining a report type parameter from the one or more parameters associated with the network monitoring request;
determining a node aggregation parameter from the one or more parameters associated with the network monitoring request, wherein the node aggregation parameter indicates one or more nodes at which aggregation functions will be performed;
determining one or more key performance indicator parameters from the one or more parameters associated with the network monitoring request, wherein each of the one or more key performance indicator parameters is associated with a specific key performance indicator; and
generating a network monitoring report based on the one or more parameters associated with the network monitoring request, the report type parameter, the node aggregation parameter, and the one or more key performance indicator parameters.

8. The method of claim 7, wherein the determining the one or more key performance indicator parameters comprises:
reading parquet files associated with each of the one or more key performance indicator parameters based on a report type being on-the-fly report;
evaluating computed data associated with the each of the one or more key performance indicator parameters, wherein the computed data includes counter data associated with the each of the one or more key performance indicator parameters; and
computing respective key performance indicator values for the each of the one or more key performance indicator parameters based on a respective formula.

9. The method of claim 1, wherein based on a report type parameter being an exception metrics report, the displaying the result of the executed network monitoring request comprises enabling a visual configuration for the each of the one or more key performance indicator parameters, wherein the visual configuration indicates a level of exceptions generated.

10. The method of claim 1, wherein the displaying the result of the executed network monitoring request comprises:
displaying a compact view of the executed network monitoring request; and
displaying a user interaction toolbar, wherein the user interaction toolbar is configured to perform one of view, preview, edit, copy, download, subscribe, or delete operations.

11. The method of claim 1, wherein subsequent to the executing the network monitoring request, the method further comprises storing the executed network monitoring request in a repository in a distributed file system of the distributed computing environment.

12. An apparatus for network monitoring in a distributed computing environment, the apparatus comprising:
a memory configured to store instructions; and
one or more processors configured to execute the instructions to
determine that a network monitoring request was triggered;
receive one or more parameters associated with the network monitoring request;
determine computing resources available in a cluster;
allocate dedicated computing resources in the cluster based on the computing resources available being insufficient;
execute the network monitoring request; and
display a result of the executed network monitoring request.

13. The apparatus of claim 12, wherein the allocating the dedicated computing resources in the cluster comprises creating a dedicated reporting queue to execute the network monitoring request.

14. The apparatus of claim 13, wherein the creating the dedicated reporting queue to execute the network monitoring request comprises allocating runtime executors based on a size of the network monitoring request.

15. The apparatus of claim 13, wherein the network monitoring request includes a plurality of network monitoring requests, and wherein the plurality of network monitoring requests are executed sequentially in the dedicated reporting queue.

16. The apparatus of claim 12, wherein the executing of the network monitoring request comprises:
determining a report type parameter from the one or more parameters associated with the network monitoring request;
determining a node aggregation parameter from the one or more parameters associated with the network monitoring request, wherein the node aggregation parameter indicates one or more nodes at which aggregation functions will be performed;
determining one or more key performance indicator parameters from the one or more parameters associated with the network monitoring request, wherein each of the one or more key performance indicator parameters is associated with a specific key performance indicator; and
generating a network monitoring report based on the one or more parameters associated with the network monitoring request, the report type parameter, the node aggregation parameter, and the one or more key performance indicator parameters.

17. The apparatus of claim 16, wherein the determining the one or more key performance indicator parameters comprises:
reading parquet files associated with each of the one or more key performance indicator parameters based on a report type being on-the-fly report;
evaluating computed data associated with the each of the one or more key performance indicator parameters, wherein the computed data includes counter data associated with the each of the one or more key performance indicator parameters; and
computing respective key performance indicator values for the each of the one or more key performance indicator parameters based on a respective formula.

18. The apparatus of claim 12, wherein the displaying the result of the executed network monitoring request comprises:
displaying a compact view of the executed network monitoring request; and displaying a user interaction toolbar, wherein the user interaction toolbar is configured to perform one of view, preview, edit, copy, download, subscribe, or delete operations.

19. A non-transitory computer-readable medium storing instructions, the instructions comprising one or more instructions that, when executed by one or more processors of a device for network monitoring in a distributed computing environment, cause the one or more processors to:
determine that a network monitoring request was triggered;
receive one or more parameters associated with the network monitoring request;
determine computing resources available in a cluster;
allocate dedicated computing resources in the cluster based on the computing resources available being insufficient;
execute the network monitoring request; and
display a result of the executed network monitoring request.

20. The non-transitory computer-readable medium of claim 19, wherein the executing of the network monitoring request comprises:
determining a report type parameter from the one or more parameters associated with the network monitoring request;
determining a node aggregation parameter from the one or more parameters associated with the network monitoring request, wherein the node aggregation parameter indicates one or more nodes at which aggregation functions will be performed;
determining one or more key performance indicator parameters from the one or more parameters associated with the network monitoring request, wherein each of the one or more key performance indicator parameters is associated with a specific key performance indicator; and
generating a network monitoring report based on the one or more parameters associated with the network monitoring request, the report type parameter, the node aggregation parameter, and the one or more key performance indicator parameters.
